(19) United States
(12) Patent Application Publication
(10) Pub. No.: US 2014/0053182 A1
(43) Pub. Date: Feb. 20, 2014

(54) METHOD AND SYSTEM FOR EVALUATING AND SHARING MEDIA

(71) Applicants: Veiko Jääger, Tallion (EE); Andras Raudsalu, Tallinn (EE); Remo Tiigirand, Tallinn (EE); Tarko Tikan, Tallinn (EE)

(72) Inventors: Veiko Jääger, Tallion (EE); Andras Raudsalu, Tallinn (EE); Remo Tiigirand, Tallinn (EE); Tarko Tikan, Tallinn (EE)

(21) Appl. No.: 13/589,358

(22) Filed: Aug. 20, 2012

(51) Int. Cl. H04N 21/45

(52) U.S. Cl. 725/25

(57) ABSTRACT

Internet TVs and other net ready displays are becoming common place and with it comes the access to an abundance of content. However accessing content on such devices is not always as quick, efficient, or secure. Thus, the present invention is implemented through controllers, server, and providers displaying a user's personalized and subscription content on any internet accessible screen. The invention does so without having to login and share personal data at the screen. All the functionality of the system and login data is managed by the user's personal controllers (i.e. smart phone or other mobile device). The server acts as a middleman in all communications between the controllers and the screens, securely storing authentication information and tokens. External content providers provide content information to the servers for conversion prior to delivery to controllers.

### TECHNICAL FIELD

The field of the present disclosure relates generally to video content delivery systems and more particularly relates to a method and system for content delivery to a video screen through the internet using a mobile device.

### BACKGROUND

Internet based content providers such as Youtube, Vimeo, Flickr, and Picasa provide users with a wealth of personalized content. Additionally, subscription services such as Netflix and HBO also provide users with even more content options. With the wealth of individualized content available, users become accustomed to having a certain amount of content available to them at all times. However, while traveling or at locations that are foreign to the user, there may not be as many content options. Thus, there exists a need for a system and method that allows access to individualized and subscription services from any location.

Portable computers and mobile devices provide users with the ability to access their content from any location with an internet connection. However, viewing content using portable computers and mobile devices may not be preferred where there is a large video screen readily accessible. Where a larger video screen is readily accessible, users may wish to display their content on the larger screen for a better viewing experience. However, connection of portable computers and mobile devices to larger video screens can be confusing, time consuming, and difficult.

Additionally, users may not always be accessing their content using their own personal devices, but instead are using public devices that may not be secure such as a computer or webtv at a hotel; thus, login information and content is not secure when using public devices. Furthermore, switching between content providers requires the user to navigate between content provider websites and enter login information. This can become bothersome when users wish to switch between several content providers quickly.

In view of the foregoing, there exists a need to securely and easily deliver and share multimedia content to a video screen using a mobile device.

### SUMMARY

An object of the present invention is to provide a quick and easy way for presenting content to any internet accessible video screen.

Another object of the present invention is to securely provide the content and protect user login information.

Objects of the invention are achieved by controllers, server, and providers to display a user's personalized and subscription content on any internet accessible screen. The invention does so without having to log in and share personal data at the screen. All the functionality of the system and login data is managed by the user's personal controllers (i.e. smart phone or other mobile device) and server. The server acts as a middleman in all communications between the controllers and the screens by securely storing authentication information and tokens. External content providers provide content information to the server for conversion prior to delivery to controllers.

Another object of the invention is to provide a platform for advertising on user's personal content by providing ads from the server to the screen and/or the controllers at predetermined times. The advertisements can also be provided between different media players.

Another object of the invention is to provide synchronized advertisements on both the screen and the controller and provide interactive advertisements or other links on the controller.

Objects of the present invention are further achieved through signaling protocols between the server and the providers. In one embodiment, the advertisements are obtained through a third party and sent to the server for transmission to the screen and/or controller. In another embodiment, the advertisements are stored on the server. Additionally, advertisements can be sent from the providers. Ads provided to the controller can by synchronized with the ad on the screen to display a unitary interactive ad which offers traversable links to flash sales offers, registration/set-up, and/or additional content and information.

Another object of the invention is to provide targeted advertising through the use of user content consumption history and profile data.

Objects of the present invention are further achieved through the server storing user profiles and content consumption histories. The server further selects advertisements to display to the user based on at least the user profile information and/or content consumption history.

### BRIEF DESCRIPTION OF THE DRAWINGS

The accompanying drawing is included as part of the present specification to illustrate the presently preferred embodiment of the present invention. Together with the general description given above and the detailed description of the preferred embodiment given below the drawing serves to explain and teach the principles of the present invention.

FIG. 1 illustrates a preferred embodiment of the invention.

### DETAILED DESCRIPTION

A method and system for quick and secure delivery of personal multimedia and pay-TV subscription content is disclosed.

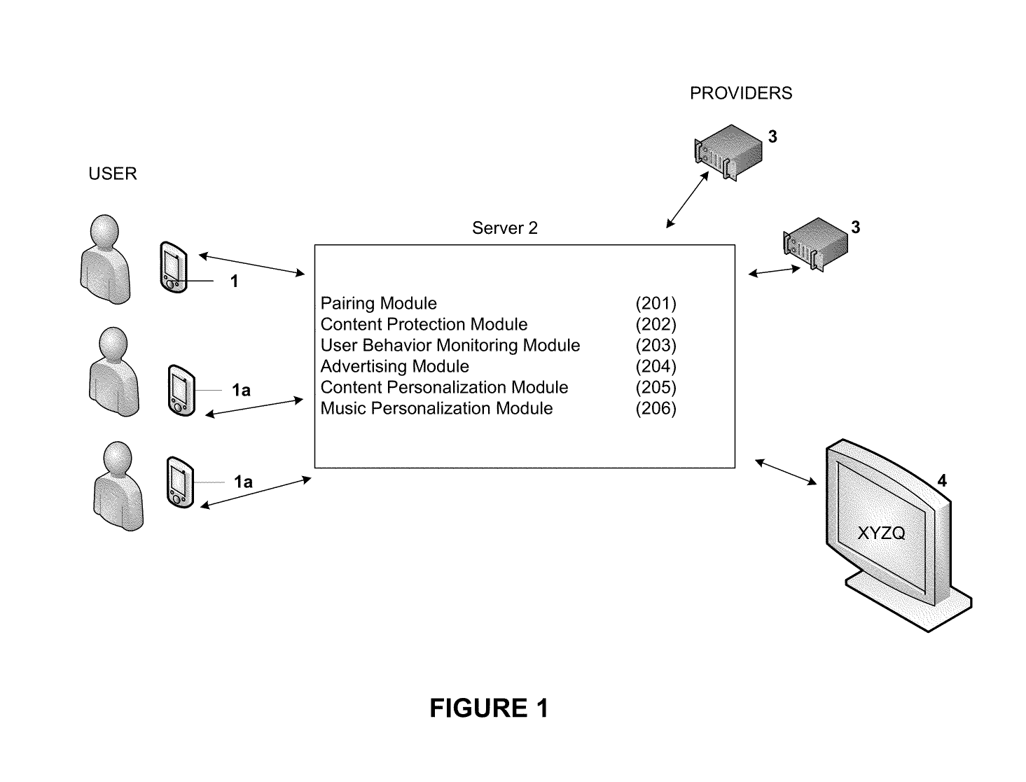

Internet TVs and other net ready displays are becoming common place and with it comes the access to an abundance of content. However, accessing content on such devices is not always quick, efficient, or secure. The concern is further heightened when a user desires to access personal content or subscription content using a foreign device such as a webTV at a hotel. Accessing one's personal or subscription content at foreign unsecure locations requires the entering of private login information on a device that may not be secure. Thus referring to FIG. 1, the present invention is implemented through controllers 1 and 1a, server 2, and providers 3 displaying a user's personalized and subscription content on any internet accessible screen 4. The invention does so without having to login and share personal data at the screen 4. All the functionality of the system and login data is managed by the user's personal controllers 1 (i.e. smart phone or other mobile device). The server 2 acts as a middleman in all communications between the controllers and the screens, securely storing authentication information and tokens. External content providers 3 provide content information to the servers 2 for conversion prior to delivery to controllers.

Discussion of the Hardware:

The invention can be implemented on any internet accessible display device 4 running in standard HTML5, JS, or Flash such as computers, smart-TVs, Set-top boxes, and gaming consoles. The screen (display device) 4 is essentially the foreign device the user wishes to display their content, but does not wish to share their login or private information on this device. The screen 4 is responsible for providing the following functionality: retrieving the necessary code from the server 2 and displaying it for pairing/connecting with the controllers 1; retrieving and displaying content (including meta information like image captions) from content providers 3 on behalf of the controller 1; managing playback operations and updating the controllers 1 with playback information (state, current position, duration, etc.); managing playback queue such as picking items from the queue and providing the data to the controllers 1; and displaying information (for example, username or avatar) about all connected controllers 1.

The controllers 1 and 1a are any mobile device such as smart phones or tablets running on a mobile operating system such as iOS or Android and serves as the main user interface. The controller 1 supports HTML5 or the equivalent or houses application embedded in the controller device 1. In one embodiment, the controller 1 need only have internet capability in order to perform the required functions. In another embodiment, the controller 1 houses a native application to perform the required functions. Additionally, multiple controllers 1a can be paired/connected with a single screen 4. The controller 1 is responsible for the following actions: signup and login operations; connecting/pairing with screens 4, authentication flow to external providers 3; browsing public content; browsing private content from providers 3 after authentication; and browsing aggregated content by content type.

The controllers 1 and screen 4 implement all the required logic to browse content, manage playback, and display. In essence, all screens 4 and controllers 1 are equal clients except that they implement different functionality. The server 2 on the other hand only serves as a middleman in all the communications between the screen 4 and the controllers 1. The server implements the functions using HTTP and JSON realtime interfaces with all connected devices and is responsible for the following actions: storing user authentication information and authentication control; storing all authentication tokens for providers 3; retrieving content information from providers 3 on behalf of the controller 1 and converting the information into compact form for delivery to the controller 1; and providing message bus and routing messages between the screen 4 and the controllers 1.

Content providers 3 are external parties that provide streamable or downloadable content to users. Providers 3 can be any personalized content sites like Youtube, Facebook, Picasa, Flickr, Vimeo, etc. where users can upload and store their own content. Additionally, providers 3 can also be subscription content such as HBO, Showtime, Netflix, etc. Providers 3 are required to have a public or private API which is used by the server 2 to access all content information and metadata. Additionally, if a proprietary media player is required, then the player is required to have a javascript API that can be used to manage playback.

The server 2 could be a provider 3 providing aggregated content feeds for each content type (all images, all videos, etc.), selected content, and social content fetched from Facebook and/or Twitter. In order to provide this additional functionality, the user is required to register with the site. Standard screen 4 and controller 1 pairing/connection does not require an account, only that both devices be logged onto the website. However, these additional functions require that a user's many content sources be linked into a single account stored on the server 2. The server performs these functions by obtaining content feeds from the providers 3, converting them to smallest form, aggregating them, and displaying them in various feed formats. Furthermore, all the login information may be securely stored on the server 2, none of which is provided to the screen 4.

Login Process:

To access the system, a user traverses to the system website on a compatible mobile browser using a controller 1 or launch a native application stored on the controller 1. The server 2 detects the device and identifies whether it is a controller 1 or a screen 4. In this instance, it is a controller 1 and thus the server 2 directs the controller 1 to the mobile interface. The mobile interface presents the user with a login option, a pairing/connecting option, and a plurality of provider 3 options. Although an account is not required, having an account enables access to additional content features such as storing login information for all providers 3, aggregated content feeds, and other personalized features. Users may login using a screen name and password which is linked to their account on the server 2 or using a social media account. The server 2 may also store all login information for any providers 3 the user may have linked to the account. Alternatively, the server may store OAuth tokens to access providers 3 in the future, which will be discussed further below. Once the user has logged in, the server 2 retrieves content feeds from the providers 3, converts them to smallest format possible, and delivers them to the controller 1 for display to the user. The user need not login first to pair/connect the controller 1 with the screen 4; login can be done at any time during the process.

Next the user is required to navigate to the same system webpage using the screen 4; the server 2 detects the device as a screen 4 and directs it to the display device interface. The display device interface then generates a unique passcode which is displayed on the screen 4. The passcode may be any combination of characters, symbols, or images. The passcode is also time sensitive and expires after a predetermined amount of time if not paired/connected with a controller 1. The user selects the pair/connect option on the controller 1 and enters the passcode displayed on the screen 4. Once the user enters the correct passcode on the controller 1, the controller 1 communicates with a pairing module 201 at the server 2 to look up the matching display device which is assigned the passcode. A connection is made and the timer for the passcode stops running so the passcode does not expire. At this point, the software at the server emulates a set-top box. In one embodiment, the server 2 is only used as a message bus between the controller 1 and the screen 4 and providing content metadata in compact form for the controller 1. The controller 1 and the screen 4 together implement all the required functionality and logic to browse content, manage playback, and display. In essence, the controller 1 and screen 4 act as equal clients accessing the content from the provider 3 however they simply implement different functionality which is communicated through the server 2 acting as a message bus.

Furthermore, messages on the bus are communicate to all controllers 1 and 1a that are connected to the screen 4. For instance, there may be additional users in the room sharing the screen which also connect to the screen 4 with their own controllers 1a in the manner discussed above. When commands are sent to the server by a controller 1, the same command is also sent to other controllers 1a as well as the screen 4. This way all controllers 1 and 1a have the current state of the screen 4.

In one embodiment, user authentication with providers 3 is managed by OAuth tokens. After pairing the controller 1 with the screen 4, the user may then select content at the controller 1 from a provider 3 to display to the screen 4. Before the content can be provided, the user must first authenticate themselves with the provider 3. In one embodiment the server 2 stores and manages all the passwords for the various providers 3. However, in another embodiment, the server 2 does not handle any of the passwords or login information. Instead, authentication with providers 3 is done through OAuth tokens which may be saved on the server 2 so that all subsequent communications are authenticated through the token. The token is stored on the server 2 thus they are never exposed to the screen 4, controller 1, or any external interface.

In order to authenticate with the provider 3, the user first selects a provider from a selection of providers displayed on the controller 1. The user is then redirected away from the mobile interface towards the provider's webpage. The user then provides login information and once authentication is successful, is directed back to the mobile interface. At the same time, the server 2 retrieves the OAuth token generated from the successful login from the provider 3 and stores it in the server 2. In future transactions, the server 2 will use the OAuth token to impersonate itself as the original user. To use this feature, the user must have an account with the server 2.

Users can also login/pair devices using a two-dimensional barcode displayed when the user navigates to the system website using the screen 4. If the user's controller 1 has a compatible camera, the user may use the camera to scan the two-dimensional barcode displayed on the screen 4 which contains all the commands necessary to pair the screen 4 and the controller 1 without having to enter in the login code as discussed above. The two-dimensional barcode automatically performs all the login steps above.

Additionally, providers 3 may be given a script to be implemented in their home webpage which scans all their media items on the page and will display a barcode next to each media item. A user who navigates to a provider's 3 home webpage on a screen 4 and wishes to play the media but at the same time pair their controller 1 can do so by scanning the barcode using the controller 1 as discussed above. More specifically, the barcode contains a unique URL to the server 2. This URL contains all the information about the screen 4 (including a unique passcode as discussed above) and media (provider 3 item ID). When the barcode is scanned, the code launches the browser on the controller 1 and initiates the login/pairing procedures automatically.

Depending on the provider 3, different options are available. These options include providing metadata about multimedia files, social media links, ratings, comments, and presenting selected content.

In some embodiments, the server 2 further comprises a content protection module 202 which provides encryption of selected content and thus may encrypt all messages between the devices. Content protection is provided in several layers. The content protection module 202 further providing the following services discussed below:

First, payload delivery is protected by HTTPS to prevent traffic interception by external parties and devices. Second, content provides non-static URLs which expire after a predetermined period of time to ensure that URLs cannot be reused. Third, all javascript in the screen 4 is fuzzed to ensure that the non-static URLs cannot be extracted. Forth, the screen 4 will make websocket calls before playing protected content to detect any HTTP proxy servers. If a proxy server is detected, the content will not be played. Fifth, the server 2 may optionally provide an additional user behavior monitoring module 203 to detect for malicious activity and monitor for unusual user activity such as screen 4 changing locations or browsers quickly. Finally, the screen 4 can be implemented as a native application on embedded platforms such as smart TVs. In other embodiments, protected content is not available on PC screens.

The server 2 may also provide an advertising module 204 for providing certain advertising content to the controller 1 in response to advertisements in the content provided by certain providers 3. One feature of the invention, the server 2 establishes a content stream with the provider 3 similar to RSS which provides the server 2 with a feed of the content as well as advertisements including when advertisement breaks are to occur in the programming stream. This way, once an advertisement is scheduled to occur, the feed notifies the advertising module 204 at the server 2 to send additional content to the controller 1. Advertisements may also occur during certain scenes of the viewing content where product placement advertising may be desirable; for instance, if there is a beverage consumed in the content, the server 2 would push product placement advertising information related to the beverage onto the controller 1. This additional content may include promotional links, coupons, surveys, and videos. The advertising module 204 can also selectively select advertisements based on user profile. User profiles can be based on a combination of any of the following features: information available on user's public profiles on social networks, user's watching habits based on previous content consumption, user reaction of previous advertisements, user's social circle reaction on previous advertisements or same advertisement. Allowing advertisements to be presented based on user profiles allow for advertisers to selectively and accurately target consumers. Additionally advertisements can be provided when a user switches between providers 3.

The server 2 may also have a content personalization module 205 that will assemble programming to match the user's interest from the user's linked accounts. The content personalization module 205 gathers data about the user's watching habits, social network profile such as their listed interests and posted videos, and popular videos from the geographical area. The content personalization module 205 effectively aggregates all of the user's content and makes a playlist so that the user can simply walk up to any screen 4 and start playing their personalized content. Additionally, the user may wish to make a playlist of content which can also be streamed in the same manner. The user can skip, add, or rearrange items on the list.

The server 2 may also have a music personalization module 206 that will create a personalized music video channel by collecting data about the user's music preferences from the user's linked accounts, viewing history, and social network profile. Once a list of artists is collected, the music personalization module then validates the list of artists to make sure that they are valid artist names and can also suggest similar artists by comparing list of artists with a master list of artists. Next, the music personalization module 206 will perform a search for tracks using the validated list of artists to generate a playlist of songs. The list can present a certain number of tracks per artists and even make recommendations. Finally, the music personalization module 206 will search known sources of music videos such as Youtube to fill the list of tracks with links to music videos. The music personalization module 206 will also exclude videos with titles including the words: lyrics, cover, remix, or parody except where the words are part of the verified artist or track name. Videos will also be preferred or displayed first if it has a greater number of hits, title includes “official”, the video author name is the artist's name, or they are an official video from a known source such as VEVO or a music label. The list is updated daily and kept dynamic and interesting by presenting different tracks from favorite artists, recommendations are also updated and changed, and artists with new tracks or latest releases are preferred. The user interface for the music video channel displays additional information relating to the currently playing track, provides links to purchase the track, and if the track is a recommended track there will be an option to add the recommended artist to the user's favorites list. Additionally, there is an option to share the user's current activity onto their social networking account.

Finally, the system can be implemented in a commercial situation such as a bar. In this situation, the screen 4 will have additional restraints and functionality. This additional functionality can be enabled when the user navigates to the system website and selects the commercial screen link. Once the screen has been designated as a commercial screen, additional functionality such as a waitlist will be implemented preventing anyone single user from having complete control of the screen. The waitlist functionality will allow a unique controller 1 to queue one selection at a time and will not display another selection until selections from other controllers have been played.

1. A method for sharing multimedia comprising:
generating an identification code for a screen;
receiving the identification code for the screen from a controller;
pairing the controller and the screen;
obtaining at least one authentication token generated by a content provider after login authentication;
storing the said at least one authentication token for reuse;
receiving a multimedia file selection from the controller after the said obtaining at least one authentication token from a content provider;
displaying the multimedia file to the screen.

2. The method of claim 1, wherein the receiving the identification code for the screen from the controller is received as a scanned barcode scanned from the screen.

3. The method of claim 1, wherein the generating an identification code for a screen further comprises determining whether the identification code has expired.

4. The method of claim 1, wherein the obtaining at least one authentication token comprises storing the authentication token in a server.

5. The method of claim 4, wherein login information and the authentication token is not shared with the screen.

6. The method of claim 1, wherein the displaying the media file to the screen further comprises:
establishing a content stream with the content provider to provide the multimedia file and a notice of when advertisements breaks are to occur;
determining whether an advertisement is to occur;
obtaining advertising content from an advertiser or the content provider; and
displaying the advertisement on the screen.

7. The method of claim 6, wherein displaying the advertisement further comprises:
displaying additional advertising content on the controller including at least one of the following: promotional links, coupons, surveys, and videos.

8. The method of claim 6, wherein the determining whether the advertisement is to occur further comprises:
determining if there has been a change in content provider;
displaying advertisement on the screen if there has been a change in content provider.

9. The method of claim 6, wherein the advertisements displayed on the screen are first selected based on user information.

10. The method of claim 9, wherein the user information can be at least one of: user profile on social networks, user's watching habits, or user's social circle reaction on similar or the same advertisements.

11. A system for quickly and securely sharing multimedia onto an internet accessible screen comprising:
a server configured to act as a messaging bus between a screen and a controller by routing all messages between the screen and controller once the screen and controller are paired together;
the server further configured to generate
unique identification codes for screens and establish a link between a screen and a controller once the unique identification code for a screen has been received from the controller;
the server further configured to receive and store an authentication token generated by a content provider once the user has entered login information using the controller so that any further transaction with the content provider does not require the user to reenter login information.

12. The system of claim 11, wherein the server is further configured to establish an advertisement feed between a content provider and the server and displaying advertising content during scheduled commercial breaks.

13. The system of claim 11, wherein the server is further configured to encrypt the multimedia payload during delivery and providing non-static perishable URLs.

14. The system of claim 11, wherein the server is further configured to generate a multimedia content playlist based on data gathered about a user which may include at least one of the following: the user's watching habits, social network profile, and popular videos from their geographic area.

15. The system of claim 11, wherein the server is further configured to manage the authentication token by associating it with a user's account on the server.

16. The system of claim 15, wherein a user's login information is never exposed to the screen.

17. The system of claim 11, wherein the unique identification code expires if not used after a predetermined amount of time.

18. The system of claim 11, wherein the server is further configured to emulate a set-top box.

19. The system of claim 15, wherein a user's account is associated with a plurality of authentication tokens.

20. The system of claim 12, wherein the server is further configured to selectively present advertisements to users based on at least one of their user profile on social networks, user's watching habits, or user's social circle reaction on similar or the same advertisements.
